(19) United States
(12) Patent Application Publication
(10) Pub. No.: US 2014/0343909 A1
(43) Pub. Date: Nov. 20, 2014

(54) METHOD AND SYSTEM FOR DYNAMICALLY MODELING A MULTIPHASE FLUID FLOW

(71) Applicant: Dominique Guerillot, Rueil Malmaison (FR)

(72) Inventor: Dominique Guerillot, Rueil Malmaison (FR)

(21) Appl. No.: 14/365,053

(22) PCT Filed: Dec. 14, 2012
(86) PCT No.: PCT/EP2012/075557

§ 371 Date: Jun. 12, 2014

(30) Foreign Application Priority Data
Dec. 15, 2011 (FR) 11 61683

(51) Int. Cl. G06F 17/50; G01V 99/00

(52) U.S. Cl. CPC G06F 17/5009; G01V 99/005
USPC 703/2

(57) ABSTRACT

A method for dynamically determining at least one physico-chemical property and the composition of a multiphase fluid flow in a porous medium: including the building of a geological model of said the porous medium and the discretization of said model into elementary meshes, the determination (40) of an initial state of each mesh, including determination of the composition of said mesh, and the determination (42) of a time-dependent change, in at least one mesh and in at least one predetermined time interval, of at least one physico-chemical property and of the composition of phases of said fluid in each component, including at least one step (52, 54) for determining an equilibrium within said mesh, comprising the application of at least the one that neuron network for determining characteristics at equilibrium of said fluid from its characteristics out of equilibrium.

The present invention relates to a method for dynamically determining at least one physico-chemical property and the composition of a multiphase fluid flow in a porous medium, said fluid comprising at least one chemical component, said method comprising:
the building of a geological model of said porous medium and the discretization of said model into a set of elementary meshes,
the determination of an initial state of each mesh, comprising the determination of the composition of said mesh in each component, and
the determination of a time-dependent change, in at least one of said meshes and in at least one predetermined time interval, of at least one physico-chemical property and of the composition of phases of said fluid in each component, including at least one step for determining an equilibrium within said mesh.

The invention in particular relates to the modeling of the transport of fluids in a porous medium at different space and time scales for simulation in rock samples in laboratories, around and in wells, notably in well tests, simulation of underground deposits, basins and petroleum systems, or simulation of the storage of fluids (hydrocarbon gases, carbon dioxide or other acid gases, waters).

Such modeling may notably be applied for localizing sedimentary basins by simulating their geological history, for predicting the location of reservoirs, the amount and composition of the hydrocarbons which may be discovered and extracted therefrom. It may also give the possibility of predicting the time-dependent change of petroleum deposits and of optimizing development of these deposits. Further, the simulation of injecting fluids in a porous medium with view to storing these fluids gives the possibility of optimizing this injection and of predicting the risks of leaks.

The storage of these fluids may be temporary or permanent (or part of the two) and may notably be accomplished in depleted gas or hydrocarbon reservoirs or during production, and in generally saline and deep aquifers.

Porous media are diverse and for example consist of carbonates, clastics, basalt, etc. and may be homogeneous or heterogeneous, faulted and/or fractured.

The modeling of the flow of fluids in a porous medium is generally carried out by discretizing the space into elementary meshes and by modeling the flow in each of these meshes.

A model thus consists of meshing, comprising a set of meshes discretizing the studied reservoir or basin, with which are associated geological and petrophysical properties, and of a flow simulator, allowing the modeling of flows of fluids within the porous medium, as well as the time-dependent change of this medium itself, for example the development of the geometry of the basin or of the properties of the rocks during CO₂ sequestration. Notably the geometry of the basin changes over time as a result of deposition, erosion, compaction processes, etc.

These fluids may be multiphase fluids and comprise an aqueous phase, a gaseous phrase, a solid phase and one or more oleic phases. Further each of the phases may consist of several components.

Such a simulator thus allows determination of the dynamic properties of the different phases in each of the meshes or on the edge of the meshes of the porous medium, such as pressures, material flow, saturations, flow rate, temperature and concentrations of the different components in each of the phases.

The modeling of the flow of fluids is carried out over a given time interval. This time interval is very variable, and may be from a few hours for well tests, 20 years for simulating an oil deposit, 1,000 years for simulating sequestration of CO₂, up to 300 million years in the case of the simulation of an oil basin.

For this, the investigated time interval is cut into time steps, for example a duration of 30 days for simulating a hydrocarbon deposit, and the simulator, for each time step and for each mesh, models the dynamic properties of the different phases.

In order to carry out this modeling, it is known how to resort to composition models which involve state equations and give the possibility of taking into account the phase transitions of different components of the investigated fluids depending on the time-dependent changes in pressure and temperature. The composition representation also gives the possibility of taking into account chemical reactions, also called geochemical reactions, which may modify the compositions of the liquid and gas phases but also the solid phases, by precipitation and dissolution phenomena.

Development of multi-phase fluids in time and space in a porous medium is governed by a system of coupled equations.

This system of equations may be solved either simultaneously or sequentially. Notably, the IMPEC scheme (for Implicit in Pressure and Explicit in Concentrations) allows decoupling of the equations relating to the transport of the fluids and of those relative to setting physico-chemical equilibrium, i.e. setting thermodynamic and/or geochemical equilibrium of fluids.

Modeling is then achieved by solving at each time step, and for each mesh the equations relating to transport of the fluids, and by establishing thermodynamic and/or geochemical equilibria in each of the meshes during this resolution.

The equations governing the transport of fluids are Darcy's Law and the conservation laws for the mass, the volume of the pores and the constituents. These equations are notably described in the article “On macroscopic equations governing multiphase flow with diffusion and chemical reactions in porous media”, Marie C. M., 2002.

For a multiphase fluid comprising nₚ phases of index α (α ∈ └1. . . nₚ┘), with respective volumes Volα, Darcy's Law allows the velocity to be expressed in each of the phases of index α, by:

$${\vec{V}}_{α} = - \frac{{k}_{r , α}}{{μ}_{α}} K ( \vec{∇} ( P + {P}_{c , α} ) + {ρ}_{α} \vec{g} ) \qquad ( 1 )$$

wherein \vec{V}ₐ designates the velocity of the fluids, k_{r,α} the relative permeability, P a reference pressure (for example the pressure of the oleic phase), P_{c,α} the capillary pressure of the phase α, □_{α} the viscosity of the phase α, □_{α} the molar density of the phase α and \vec{g} is the gravity acceleration vector.

The fluid comprises n, components, each present in at least one of the phases, and with mass fractions

$${C}_{i}^{α} = \frac{{m}_{α}^{i}}{{m}_{α}}$$

in each phase α, wherein m_{α}ⁱ designates the mass of component i in phase α and m_{α} is the mass of the phase α. These components for example comprise hydrocarbons of the general formula CₚH₂ₚ₊₂, methane, water and carbon dioxide.

Conservation of the mass is given for each component of index i by:

$${\partial }_{t} ( φ {\sum }_{α}^{ } {ρ}_{α} {C}_{i}^{α} {S}_{α} ) + div ( {\sum }_{α}^{ } {ρ}_{α} [ {C}_{i}^{α} \vec{{V}_{α}} - {D}_{i}^{α} \vec{∇} {C}_{i}^{α} ] ) = {Q}_{i} \qquad ( 2 )$$

wherein

$${S}_{α} = \frac{{Vol}_{α}}{{Vol}_{pore}}$$

is the saturation of the phase α, Dᵢ^{α} is the dispersivity tensor of component i in the phase α, Qᵢ is the source term and φ is the porosity.

If a coupling between chemical reactions and the transport of the components is taken into account, equation (2) becomes:

$${\partial }_{t} ( φ {\sum }_{α}^{ } {ρ}_{α} {C}_{i}^{α} {S}_{α} ) + div ( {\sum }_{α}^{ } {ρ}_{α} [ {C}_{i}^{α} \vec{{V}_{α}} - {D}_{i}^{α} \vec{∇} {C}_{i}^{α} ] ) - \partial t ( [ 1 - φ ] {ρ}_{r} {\sum }_{α}^{ } {C}_{i}^{α} {\vert}_{reac} ) = {Q}_{i} \qquad ( {2}^{′} )$$

Wherein □ᵣ designates the density of the solid medium and

$$\partial t ( {\sum }_{α}^{ } {C}_{i}^{α} {\vert}_{reac} ) \qquad$$

represents the variation of the concentration of the component i due to the chemical reactions, including reactions which are instantaneously in equilibrium and reactions which are in equilibrium according to given kinetics.

Moreover, conservation of the volume of the pores imposes:

$${\sum }_{α}^{ } {S}_{α} = 1 \qquad ( 3 )$$

and conservation of the components imposes:

$${\sum }_{i}^{ } {C}_{i}^{α} = 1 \qquad ( 4 )$$

Most of these equations are time and space partial derivative equations. Others are non-linear equations, most of the “closed” kind for having as many equations as there are unknowns. Initial conditions and boundary conditions are further necessary so that the problem is properly posed.

In the composition simulations of a reservoir (i.e. considering the compositions of the fluids), it is generally assumed that local thermodynamic equilibrium between all the phases exists everywhere in the reservoir within each time step. The setting of physico-chemical equilibrium is thus achieved at each time step and for each mesh, by solving the thermodynamic and/or geochemical equations by calculations, called “flashes” in the case of thermodynamic equations.

Notably, thermodynamic calculations, carried out on each mesh, allows determination of the compositions and properties of each phase at equilibrium, from the pressure, the temperature and overall compositions of the mesh out of equilibrium, as determined from the transport equations.

These thermodynamic calculations are based on the equality of the fugacities of the components between the phases and on a state equation.

When several phases are at equilibrium, the fugacities of a given component in the different phases are equal. For example, for a component with an index i ∈ [1 . . . n_{c}] present in two phases of respective indexes o and v, the equality of the fugacities is expressed by:

In fᵢₒ=In fᵢᵥ (5)

wherein fᵢₒ designates the fugacity of the component i in the phase o and fᵢᵥ its fugacity in the phase v. In a system with n_{c} components, equality of the fugacities of each component in both of these phases is therefore expressed by a system of n_{c} equations. Moreover it is noted that

$${N}_{i} = φ {\sum }_{α}^{ } {ρ}_{α} {C}_{i}^{α} {S}_{α}$$

the number of moles of component i per unit volume in the whole of the phases a and Nᵢₒ and Nᵢᵥ respectively are the number of moles of component i per unit volume in the respective phases o and v, these numbers of moles verifying:

Nᵢₒ+Nᵢᵥ=Nᵢ.

The components may of course change phase.

From the state equations of each phase, it is possible to express the fugacities according to the number of moles with an equation of the type

$$ln ( \frac{{f}_{i}}{{y}_{i} P} ) = \frac{1}{RT} {\int }_{ω}^{∞} ( {( \frac{\partial P}{\partial {N}_{i}} )}_{T , ω , {N}_{j \neq i}} - \frac{RT}{V} ) d ω - ln \frac{PV}{RT} \qquad ( 6 )$$

wherein

$${y}_{i} = \frac{{N}_{i}}{{\sum }_{i = 1}^{{n}_{c}} {N}_{i}}$$

designates the molar fraction of the component i, R is the universal ideal gas constant, ω the relevant volume and T the temperature.

The relevant state equations are generally of the type:

$$P = \frac{RT}{V - b} - \frac{a}{( V + {c}_{1} b ) ( V + {c}_{2} b )} ,$$

associated with laws of mixtures:

$$a = {\sum }_{i = 1}^{{n}_{c}} {\sum }_{j = 1}^{{n}_{c}} {y}_{i} {y}_{j} ( 1 - {d}_{ij} ) \sqrt{{a}_{ii} {a}_{jj}} et b = {\sum }_{i = 1}^{{n}_{c}} {y}_{i} {b}_{i} ,$$

wherein c₁ and c₂ are constants, aᵢᵢ are the parameters of pure substances and d₁ are interaction coefficients between the components of indexes i and j within the mixture.

Notably, the two most used state equations are that of Soave, Redlich and Kwong (or SRK) and that of Peng-Robinson (or PR).

The setting of thermodynamic equilibrium thus consists of determining the compositions of each of the phases so as to observe the equality of the fugacities of the components in the different phases while observing the component conservation equations.

The setting of geochemical equilibrium is moreover achieved from geochemical equilibrium equations with given constants Kᵢ, the compositions of each of the phases being determined so that these equations are verified.

In practice, the transport equations are solved by means of an iterative algorithm comprising several iterations during which setting of equilibrium is carried out so that several flashes are carried out for each mesh at each time step.

These equilibrium calculations account for a highly significant portion of the total time required for a simulation. For example, a conventional simulation in three space dimensions of a deposit with an extension of a few kilometers and a thickness of about 100 meters during 20 years of production requires a million meshes and Nₚₜ=240 time steps of one month. If it is considered that 5 iterations are required at each time step, 1.2 thousand million flashes are required for setting thermodynamic equilibrium.

These flashes thus represent between 30% and 80% of the total cost of a simulation in terms of computations. Now, a simulation may last for several hours.

In order to limit the required computing time and power, the number of components taken into account by the model and the number of meshes discretizing the porous medium have to be reduced. However, such a solution has the effect of also reducing the resolution and the exactness of the obtained results.

The object of the invention is therefore to allow reliable modeling of a multi-phase porous flow while reducing the required computing time and power for this modeling, by optimizing the ratio between the accuracy of the modeling and the required time and power.

For this purpose, the object of the invention is a method of the aforementioned type, characterized in that the determination of the equilibrium within said mesh comprises the application of at least one neuron network, able to determine characteristics at equilibrium of said fluid from characteristics out of equilibrium of said fluid. According to other aspects of the invention, the modeling method comprises one or several of the following features.
the step for determining a time-dependent change of at least one physico-chemical property and of the composition of phases of said fluid comprises the determination of said physico-chemical property and of the composition of the phases of said fluid in each chemical component at the end of said time interval, from the physico-chemical property and the composition of the phases of said fluid in each chemical component at the end of a previous time interval;
the step for determining a time-dependent change of at least one physico-chemical property and of the composition of the phases of said fluid comprises for each pre-determined time interval, resolution of the transport equations of said fluid between the meshes, followed by the step for determining an equilibrium within each mesh;
said physico-chemical property is comprised in the group comprising temperature, pressure, viscosity, specific gravity, saturation and capillary pressure of the phases of said fluid;
the method comprises a step for establishing said neuron network, comprising the determination of a structure of said neuron network and the determination of parameters of said network;
the step for establishing said neuron network comprises a step for forming a database of examples comprising learning examples, the step for determining parameters of said network comprising at least one statistical learning step of said network from said learning examples;
the step for forming a database of examples comprising the application of an experiment plan;
said equilibrium is a thermodynamic or geochemical equilibrium;
the step for determining the equilibrium within said mesh comprises the application of a first thermodynamic neuron network, able to determine characteristics of said fluid at thermodynamic equilibrium from characteristics of said fluid out of equilibrium, and the application of a second geochemical neuron network, able to determine characteristics of said fluid at geochemical equilibrium from characteristics of said fluid out of equilibrium.

The object of the invention is also a system for dynamically determining at least one physic-chemical property and a composition of a multi-phase fluid flow, said fluid comprising at least one chemical component, comprising;
means for building a geological model of said porous medium and for discretizing said model into a set of elementary meshes,
means for determining an initial state of each mesh, comprising means for determining the composition of said mesh in each component, and
means for determining a time-dependent change, in at least one of said meshes and in at least one pre-determined time interval, of at least one physico-chemical property and of the composition of phases of said fluid in each component, including means for determining at least an equilibrium within said mesh,
   said system being characterized in that the means for determining said equilibrium comprises means for applying at least one neuron network, able to determine characteristics at equilibrium of said fluid from characteristics out of equilibrium of said fluid.

The invention will be better understood by means of the description which follows only given as an example and made with reference to the appended drawings wherein:

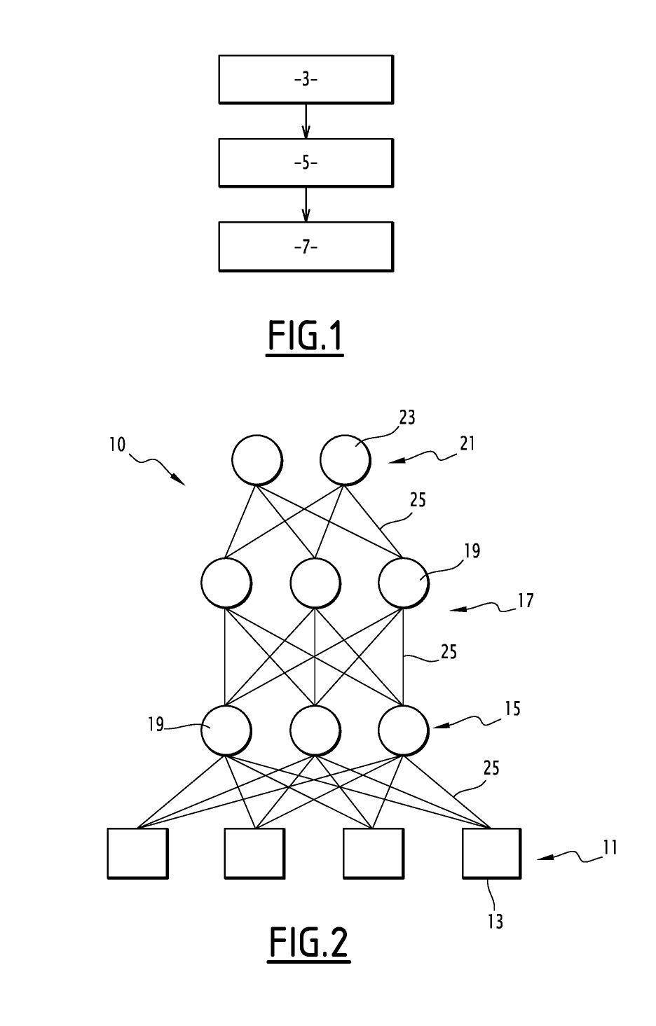

FIG. 1 is a flow chart illustrating the different steps of a modeling method according to the embodiment of the invention;

FIG. 2 is a schematic illustration of a neuron network;

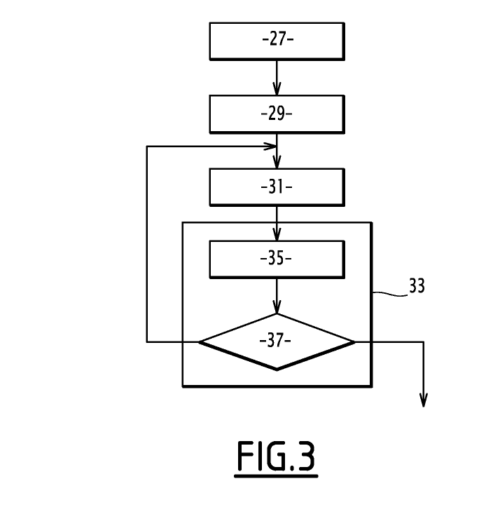

FIG. 3 illustrates in a detailed way a step of the method illustrated in FIG. 1; and

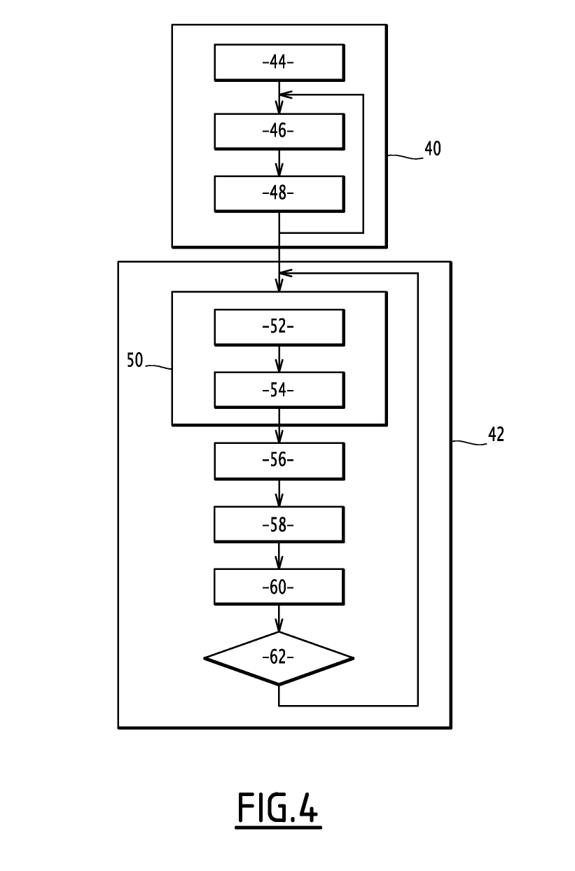

FIG. 4 illustrates in a detailed way another step of the method illustrated in FIG. 1.

The invention relates to a method for modeling a multiphase flow in a porous medium, wherein the transport phenomena are modeled by solving conventional transport equations, and wherein the settings of thermodynamic and/or geochemical equilibrium are not carried out by solving thermodynamic equations (thermodynamic “flashes”) or geochemical equations, but by means of a neuron network.

Thus, the thermodynamic or geochemical equations forming a “white box” model of the model system are replaced with a model of the “black box” type not requiring resolution of equations.

In FIG. 1, the main steps of a modeling method according to an embodiment of the invention are illustrated, for modeling the flow of a multi-phase fluid in a porous medium, for example, a reservoir comprising two wells, including an injector and a producer.

The reservoir is located underground in a given geological environment. The wells connect the reservoir to a point of the surface. The producing well will be used for extracting hydrocarbons on site, while the injecting well will be used for introducing into the reservoir a replacement fluid (water or gas, for example).

This method comprises a step 3 for defining the flow to be modeled. During this step, the characteristics of the reservoir and of the fluid for which the flow is modeled are determined.

Notably, a three dimensional model of the space characteristics of the reservoir is determined, and this model is then discretized into elementary meshes with which geophysical and petrophysical properties are associated, for example, a permeability value. This meshing may for example be achieved from maps of geological and petrophysical properties inferred from geophysical measurements.

The elementary meshes may be of any shapes, and notably cubic or parallelepipedal shapes, such as elements with eight apices called “‘corner points”. The meshes are for example cubic meshes, with a side measuring 50 m and the reservoir is for example discretized into 250,000 meshes.

Moreover, the different phases to be considered, for example an aqueous phase, a vapor phase, an oleic phase and one or several solid phases are determined, as well as the initial composition of each phase and the geochemical equilibria to be taken into account during the modeling by considering the mineralogy of the porous medium which the fluids will encounter.

Further, the modeled time extent is defined, as well as the time step ΔT.

Next, in a step 5, first and second neuron networks able to respectively model the thermodynamic and geochemical behavior of each mesh are established.

In a modeling step 7, the flow of the fluid is modeled, the transport phenomenon being modeled by solving conventional transport equations, the setting of thermodynamic and/or geochemical equilibria in each mesh being carried out by means of neuron networks established during step 5.

These steps are advantageously applied with a modeling system comprising a computer. This computer for example comprises a computing unit, a memory, and a man-machine interface means allowing interaction with the user.

An example of a neuron network is illustrated in FIG. 2. A neuron network is a mathematical object comprising a plurality of formal neurons achieving a parameterized non-linear algebraic function, with boundary values, real variables called inputs, and the value of which depends on parameters called coefficients or weights.

Generally, the formal neurons achieve a sum of the received inputs, weighted by coefficients assigned to these inputs, and then apply to the obtained value an “activation function” f. The mathematical function produced by a formal neuron comprising n inputs xₖ of respective weights eₖ may thus be written as:

$$y = f ( {θ}_{0} + {\sum }_{k = 1}^{n} {θ}_{k} {x}_{k} ) ,$$

The parameter θ₀ being a parameter associated with an input set to 1, called a bias. The most currently used activation functions are the hyperbolic tangent function, the non-linear sigmoid function and the identify function.

The neuron network 10 illustrated in FIG. 2 comprises a layer of inputs 11 comprising four input variables 13, a first 15 and second hidden layer 17 each comprising three hidden neurons 19 and an output layer 21 comprising two output neurons 23. The input variables 13 have a value set by the user, while the output neurons 23 correspond to the quantities computed by the neuron network 10.

The neurons of a given layer are connected to all the neurons or inputs of the adjacent layers through connections 25 called synapses which represent parameters or weights of the network. Each neuron embodies a non-linear function of a sum of output values of the neurons of the preceding layer weighted by the corresponding weights, as indicated above. The function f associated with the output neurons is generally linear, while the function f associated with the hidden neurons, identical for all the neurons, is generally non-linear.

Thus, the output values of the network 10 depend both on the values of the input variables which may assume any values, and on the values of the parameters, which are set during establishment of the model. A neuron network thus embodies one or several algebraic functions of its input, by composition of the functions embodied by each of its neurons, and therefore gives the possibility of calculating one or several quantities from input data or variables.

The number of degrees of freedom, i.e. of adjustable parameters, depends on a number of neurons of the hidden layer, it is therefore possible to vary the complexity of the network by increasing or reducing the number of hidden neurons.

FIG. 3 illustrates step 5 for establishing a neuron network for the modeling of the setting of a mesh to thermodynamic or geochemical equilibrium.

The establishment 5 of a neuron network comprises a step 27 for defining inputs and outputs of the network, a step 29 for forming a database of examples, a step 31 for determining a suitable network structure and a step 33 for determining values of the parameters of the network.

During step 27, the number of inputs and outputs of the network is defined. Notably, in the case of setting thermodynamic equilibrium of the system, the neuron network is intended to determine the compositions of each of the phases of the fluid as well as the properties of this fluid at equilibrium, which thus forms the outputs of the neuron network, from the pressure, the temperature and the overall composition of the fluid, which form the input variables of the network. The neuron network is thus intended to replace the resolution of the equilibrium equations of the fugacities described above. Thus, the output variables determined by the neuron network comprise at least the unknowns of the flash computation algorithms.

For example, for a bi-phasic fluid comprising Nₒ components, the network comprises N_{c} input variables each corresponding to the number of moles Nᵢ of a component i per unit and volume in the relevant mesh, and two input variables respectively corresponding to the temperature and to the pressure in this mesh.

Moreover the network includes N_{c} outputs giving the number of moles of each component i per unit volume in one of the phases, i.e. Nᵢₒ or Nᵢᵥ, the number of moles in the second phase may be inferred via the equalityNᵢₒ+Nᵢᵥ=Nᵢ. The network also includes outputs for example, giving the saturation and the compressibility factor Z of each of the phases.

The network therefore comprises in this example N_{c}+2 inputs and N_{c}+4 outputs.

The coefficients or weights of a neuron network are determined by learning, from examples of inputs and output pairs forming a set comprising Nₑₓexamples.

These examples consist of a set of Nₑₓ vectors of input variables {xₖ, k=1 . . . Nₑₓ} and of a set of Nₑₓ vectors of the modeled quantities {yₖ(xₖ), k=1 . . . Nₑₓ}.

Thus, during step 29, a database comprising Nₑₓ vectors of input variables and Nₑₓ vectors of the corresponding outputs is formed.

The Nₑₓ vectors of input variables are first of all selected, within an experimental space defined by lower and upper boundaries of the contemplated input variables.

For example, in the case of setting thermodynamic equilibrium, the selected input variable vectors are of the type xₖ={Tₖ, Pₖ, N₁ₖ, N₂ₖ . . . }, with Tₘᵢₙ<Tₖ<Tₘₐₓ, Pₘᵢₙ<Pₖ<Pₘₐₓ and Nᵢₘᵢₙ<Nᵢₖ<Nᵢₘₐₓ.

The vectors of input variables are advantageously selected by means of an experimental plan, giving the possibility of finding the optimum examples and of minimizing the number of examples required for determining the values of the parameters of the network. Notably, the base of examples advantageously comprises stronger data density around phase and/or chemical equilibrium change envelopes, so as to represent the phase transitions at best.

Once these input vectors are selected, the vectors {yₖ(xₖ)k=1 . . . Nₑₓ} of the corresponding outputs are determined by means of conventional thermodynamic or geochemical calculations or flashes, as described above.

For example, for a fluid comprising 10 components, the number of input variables is equal to 12. If the selected experimental plan is of the factorial type, the number Nₑₓ of examples, therefore of thermodynamic calculations to be performed, is 2^{Nc+2}=4096 flashes. The number Nₑₓ of examples is then equal to 4096.

Moreover, step 29 comprises the formation from the database of examples, of a base or a learning set comprising Nₐₚₚ learning examples, and of a complimentary validation base or set comprising Nᵥₐₗ validation examples, this base may generally comprise from 1 to Nₐₚₚ/2 examples.

The learning base is intended to allow determination of parameters of the neuron network, and the validation base is intended to allow the selection of a particular model and its evaluation.

The structure of a neuron network is determined by the number of hidden layers which it includes and the number of neurons hidden in each of these layers which define the complexity of the network.

Thus, during step 31, the number of hidden layers and the number of neurons in these layers are selected. The number of hidden layers is for example equal to two. The number of hidden neurons may be temporary and adjusted subsequently so as to attain optimum modeling by the neuron network. During step 31, the function for activating the hidden neurons and the function for activating output neurons are also selected.

The step 33 for determining the values of the parameters of the network comprise a step 35 for determining values of the parameters of the network from the learning base and a step 37 for selecting the best model and for evaluating the obtained model.

The determination 35 of the values of the parameters 25 consist of optimizing the values of the parameters of the neuron network by means of examples of the learning base. Learning is advantageously carried out by minimizing the least square cost function J defined by:

$$J ( θ ) = \frac{1}{2} {\sum }_{k = 1}^{{N}_{app}} {( {y}_{k} ( {x}_{k} ) - g ( {x}_{k} , θ ) )}^{2}$$

wherein g designates the vector of the outputs of the neuron network. The learning thus consists of finding the vector of parameters A minimizing the error of the network.

The minimization of this function is carried out in a known way with a gradient descent algorithm, iteratively converging towards a minimum of the cost function, from random initial values of the parameters.

Since the function g is non-linear, the function J generally has a plurality of local minima. Thus, in order to determine the vector A leading to the best model, the algorithm is advantageously performed several times, for example 20 times, from different initializations of the parameters. Each of the N_{mod} thereby obtained models is defined by a particular vector of parameters, noted as θᵢ.

The learning cost EA of each obtained model is defined by:

$${E}_{A}^{i} = \sqrt{\frac{1}{{N}_{app}} {\sum }_{k = 1}^{{N}_{app}} {( {y}_{k} ( {x}_{k} ) - g ( {x}_{k} , {θ}_{i} ) )}^{2}}$$

In step 37, the best of these N_{mod} models is selected and the quality of the selected model is evaluated.

The learning cost alone is not a good indicator of the quality of the model; a good model should actually be capable of accounting for the deterministic relationship between the variables and the model quantities, without being adjusted to the noise of the learning data.

The selection of the model is for example achieved from the validation database by computation, for each of the N_{mod} models obtained, of the validation costs Eᵥⁱ, given by:

$${E}_{v}^{i} = \sqrt{\frac{1}{{N}_{val}} {\sum }_{k = 1}^{{N}_{val}} {( {y}_{k} ( {x}_{k} ) - g ( {x}_{k} , {θ}_{i} ) )}^{2}}$$

The lowest cost validation model which is therefore the best model in generalization, is then selected.

Alternatively, the quality of the model may be evaluated by crossed validation, or by the technique of the actual or virtual leave-one-out.

If the model is not satisfactory, i.e. if the learning cost of the selected model is greater than a pre-determined threshold or if the validation cost or the leave-one-out score or the cost validation score is greater than a pre-determined threshold, the complexity of the model has to be modified. For this, in a new step 31, the number of hidden layers and/or the number of neuron in these layers are modified.

Steps 31 and 33 are thus reiterated until a satisfactory model is obtained, i.e. for which the learning and validation scores are less than pre-determined thresholds.

Once the learning phase of the neuron network is achieved, the latter may be applied for determining the compositions and properties of the fluid at equilibrium in each mesh, within the limits of the experimental space defined in step 29.

The thermodynamic neuron network is thus able to determine by itself, from data out of equilibrium such as the number of moles Nᵢ of each component i per unit volume, the temperature and the pressure, of the properties and compositions at equilibrium, such as the composition of each phase, i.e. the number of moles of each component i in each phase, as well as the saturations, viscosities and specific gravities of each of the phases, without applying any additional thermodynamic calculation.

Also, the geochemical neuron network is able to determine by itself the constitution of each phase at chemical equilibrium from the given information on the components out of chemical equilibrium, without applying any additional geochemical calculation.

FIG. 4 thus illustrates the step 7 for modeling the flow of fluid.

The equations governing this flow are for example the equations 1 to 4 above. After discretizations in time and in space, this set of equations leads to a system of coupled non-linear equations, for example, solved sequentially with all or part of the variables.

Different linearization methods are possible for solving these systems. In the following the Newton method will be considered.

The modeling 7 is achieved by solving at each time step, and for each mesh, the equations relating to the transport of the fluids and by establishing the thermodynamic and/or geochemical equilibria in each of the meshes.

The modeling 7 thus comprises an initialization step 40 and a plurality of iterations 42 forming a loop allowing determination of a time-dependent change of each mesh at each time step. The number of iterations is therefore generally equal to the number Nₚₜ of time steps.

During the initialization step 40, a user provides to the modeling system, in a step 44, the information on the flow to be modeled as determined during step 3. This information comprises the meshing of the reservoir, comprising its geometry and its petrophysical characteristics, as well as the initial amount of each component of the fluid.

From this initialization data, an initial equilibrium state EQ₀ is determined, in particular comprising the initial properties of the fluid in each phase and in each mesh, and notably the total and partial pressures in each phase, the temperatures, viscosities and specific gravities of the different phases.

For this purpose, in a step 46 for setting thermodynamic equilibrium, the modeling system carries out a setting of thermodynamic equilibrium, by means of the thermodynamic neuron network established during step 5. The pressure, temperature and the number of moles Nᵢ of each component i per unit volume are thus provided at the input to the thermodynamic neuron network. The latter then determines, with the parameters determined during step 5, the composition of each phase, as well as the saturations, viscosities and specific gravities of each of the phases, at thermodynamic equilibrium.

This step 46 is followed by a step 48 for setting geochemical equilibrium, upon which the modeling system determines a geochemical equilibrium by means of the geochemical neuron network established during step 5. The composition of each of the phases at geochemical equilibrium is thus determined from their compositions out of geochemical equilibrium.

This step 48 is capable of disrupting the previously established thermodynamic equilibrium. Both steps 46 and 48 are reiterated, for example between one and ten times, until the initial thermodynamic and geochemical equilibrium has been established. The number of iterations depends on the selected time step. It is all the greater since the time step is large.

Then, during step 42, the modeling system determines the time-dependent change in the characteristics of each mesh during the relevant time step ΔTₙ. This step 42 is itself a loop carried out iteratively. During the step, the modeling system determines the physico-chemical properties of the phases of the fluid and the composition of these phases in each component at the end of the time step ΔTₙ, from physico-chemical properties of the phases of the fluid and from the composition of these phases at the end of the previous time interval ΔTₙ₋₁.

In a step 50, the system determines a thermodynamic and chemical equilibrium state EQₙ at the beginning of the time step ΔTₙ, i.e. the properties of the fluid at equilibrium in each phase and in each mesh at the beginning of this time step.

This step 50 is superfluous for the first time step, since each mesh is at equilibrium at the end of step 40 (EQ₁=EQ₀).

Step 50 comprises for this purpose a step 52 for setting thermodynamic equilibrium, identical with step 46 described above, and a step 54 for setting geochemical equilibrium, identical with step 48 above.

In a step 56, the modeling system determines, from saturations determined during step 50, relative permeabilities k_{r,α} and capillary pressures P_{c,α} in each phase and each mesh. These properties are actually required for solving the Darcy equation (1) indicated above. These characteristics are determined in a known way from tables giving the relative permeabilities and capillary pressures as a function of the saturations.

Moreover, the system determines the molecular weights of the oleic and gas phases, from the molecular weights MWᵢ of each of the components and from the composition of these phases.

The system also determines the viscosities for each phase, for example by the Lorentez-Bay-Clark method described in document “Calculating Viscosities of Reservoir Fluids from their Composition” (Journal of Petroleum Technology, Vol. 16, N. 10, October 1964, pp. 1171-1176).

Next, in a step 58, the modeling system determines for each mesh the new values of the evolving boundary conditions, in order to notably take into account the conditions of an open or closed well, and the variations of the flow rates and pressures due to external factors.

The modeling system determines in a step 60, the transport and accumulation terms of equation (2) above, respectively equal to

$${\partial }_{t} ( φ {\sum }_{α}^{ } {ρ}_{α} {C}_{i}^{α} {S}_{α} ) and div ( {\sum }_{α}^{ } {ρ}_{α} [ {C}_{i}^{α} \vec{{V}_{α}} - {D}_{i}^{α} \vec{∇} {C}_{i}^{α} ] ) ,$$

and then determines by solving the discretized transport equations, the new compositions, pressures and velocities of each of the phases for each mesh, due to the transport of the fluid between the meshes.

This transport equation is solved for the whole of the meshes.

The system then performs a conversion test in a step 62, notably for checking whether the material balances are correct.

If this test proves to be negative, the system again applies steps 50 to 62 above, while retaining the same time step ΔTₙ.

If this test is positive, the compositions, pressures and velocities of the phases of each mesh are considered like the compositions, pressures and velocities at the end of the time step ΔTₙ. In a step 64, these data are recorded and the time step is incremented. The number of iterations thereby carried out within the loop 42 is on average equal to five.

The number of iterations also depends on the selected time step. When the time step is short, one iteration is sufficient. When the time step is longer, sudden phase transitions may occur and more iterations, for example ten, are required for obtaining equilibrium. If the number of iterations exceeds a pre-determined threshold, without equilibrium being attained, the time step is divided by two or three and step 42 is re-initialized with this new time step.

Step 42 is then reiterated for the next time step ΔTₙ₊₁, and then the next one up to the time step ΔT_{Npt}.

The loop 42 is similar to the conventionally applied loops according to the Newton method, but differs from these conventional loops in that the settings of thermodynamic 46, 52 and geochemical 48, 54 equilibrium are carried out by means of neuron networks, and not by resolution of thermodynamic or geochemical equation systems.

The result of this is a considerable gain in time, since once the neuron networks are established during step 5, the application of these networks for setting equilibrium requires very short execution time relatively to thermodynamic or geochemical flashes.

Further, the establishment of the neuron networks itself requires low computing resources. Notably, as indicated earlier, 2^{Nc+2} thermodynamic/geochemical flashes may be sufficient for teaching the neuron networks, i.e. about 300,000 times less than the number of flashes required for modeling according to the state of the art.

It should be understood that the exemplary embodiment shown above is not limiting.

Notably, the discretization method may be different from an “IMPEL” scheme, for example a scheme of the “IMPIM” type i.e. implicit in pressure and in mass, or a scheme of the “SOLSS” type, in which no coupling term is neglected.

Further, it may be contemplated to only replace the thermodynamic flashes or only the geochemical flashes, with neuron networks.

Moreover, any equilibrium calculation may be replaced with a neuron network, the method not being limited to thermodynamic and geochemical equilibrium.

Moreover, the modeling method according to the invention may be applied to any type of natural or artificial porous media, such as cement in the surroundings of wells.

It may notably be applied for simulating injections and sequestrations of gases such as greenhouse gases (CO₂, CH₄, etc.) for storage in hydrocarbon reservoirs, saline aquifers or other geological formations, or injections of gas for increasing or maintaining the pressure in a reservoir, injections of miscible gases. It is also possible to apply for modeling injections into thick reservoirs with a composition gradient due to gravity, injections in reservoirs with fluid compositions close to the bubble and/or dew points, or injections of sea water either mixed or not with aquifer and production waters.

This modeling method may moreover be used within the scope of recovery studies either secondary or tertiary, for modeling the production of high pressure and/or high temperature reservoirs or fractured and/or cracked reservoirs and in the study of methods said to be for assisted recovery of hydrocarbons.

It may also be used for evaluating the impacts of the precipitation of asphaltenes and/or paraffinic compounds during production, for taking into account combustion phenomena in situ (for example, injection of air), biodegradation, degradation of radioactive traces, and taking into account reactions of non-balanced equations or during geothermal power studies, studies for managing nuclear waste or environmental studies involving transfers in porous media with composition representations of the fluids.

Other applications may of course be contemplated, and the technical characteristics of the embodiments and alternatives mentioned above may be combined with each other.

1. A method for dynamically determining at least one physico-chemical property and the composition of a multiphase fluid flow in a porous medium, said fluid comprising at least one chemical components, said method comprising:
the building of a geological model of said porous medium and the discretization of said model into a set of elementary meshes,
the determination of an initial state of each mesh, comprising the determination of the composition of said mesh in each component, and
the determination of a time-dependent change, in at least one of said meshes and in at least one predetermined time interval, of at least one physico-chemical property and of the composition of phases of said fluid in each component, including at least one step for determining an equilibrium within said mesh,
said method being characterized in that the determination of the equilibrium within said mesh comprises the application of at least one neuron network, able to determine characteristics at equilibrium of said fluid from characteristics out of equilibrium of said fluid.

2. The determination method according to claim 1, in that wherein the step for determining a time-dependent change of at least one physico-chemical property and the composition of phases of said fluid comprises the determination of said physical-chemical property and the composition of phases of said fluid in each chemical component at the end of said time interval, from the physico-chemical property and from the composition of the phases of said fluid in each chemical components at the end of a preceding time interval.

3. The determination method according to claim 1, wherein the step for determining a time-dependent change of at least one physico-chemical property and the composition of the phases of said fluid comprises for each predetermined time interval the resolution of transport equations of said fluid between the meshes, followed by the step for determining an equilibrium within each mesh.

4. The determination method according to claim 1, wherein said physico-chemical property is comprised in the group comprising temperature, pressure, viscosity, specific gravity, saturation and capillary pressure of the phases of said fluid.

5. The determination method according to claim 1, further comprising a step for establishing said neuron network, comprising the determination of a structure of said neuron network and the determination of parameters of said network

6. The determination method according to claim 5, wherein the step for establishing said neuron network comprises a step for forming a database of learning examples, the step for determining parameters of said network comprising at least one step for statistically learning said network from said learning examples.

7. The determination method according to claim 6, wherein the step for forming a database of examples comprises the application of an experimental plan.

8. The determination method according to claim 1, wherein said equilibrium is a thermodynamic or geochemical equilibrium.

9. The determination method according to claim 8, wherein the step for determining equilibrium within said mesh comprises the application of a first thermodynamic neuron network, able to determine characteristics at thermodynamic equilibrium of said fluid from characteristics out of equilibrium of said fluid, and the application of a second geochemical neuron network, able to determine characteristics at geochemical equilibrium of said fluid from characteristics out of equilibrium of said fluid.

10. A system for dynamically determining at least one physico-chemical property and the composition of a multiphase fluid flow, said fluid comprising at least one chemical component, comprising:
means for building a geological model of said porous medium and for discretizing said model into a set of elementary meshes,
means for determining an initial state of each mesh, comprising means for determining the composition of said mesh in each component, and
means for determining a time-dependent change, in at least one of said meshes and in at least one predetermined time interval, of at least one physico-chemical property and of the composition of phases of said fluid in each component, including means for determining at least an equilibrium within said mesh,
said system wherein the means for determining said equilibrium comprises means for applying at least one neuron network, able to determine characteristics at equilibrium of said fluid from characteristics out of equilibrium of said fluid.
